(19) United States
(12) Patent Application Publication
(10) Pub. No.: US 2016/0003703 A1
(43) Pub. Date: Jan. 7, 2016

(54) METHOD FOR TESTING LED EXPLOSION-PROOF LAMP CHAMBER AND STRUCTURE THEREOF

(71) Applicant: Li-Hong Science & Technology Co., Ltd., Kaohsiung (TW)

(72) Inventors: Ming-Tien Chien, Kaohsiung (TW); Ching-Yuan Juan, Kaohsiung (TW); Han-Wen Chang, Kaohsiung (TW); Cheng-Lung Juan, Kaohsiung (TW)

(21) Appl. No.: 14/488,615

(22) Filed: Sep. 17, 2014

(30) Foreign Application Priority Data
Jul. 7, 2014 (TW) 103123276

(51) Int. Cl. G01M 3/04; F21V 31/00; F21V 15/00

(52) U.S. Cl. CPC G01M 3/04; F21V 15/00; F21V 31/005; F21Y 2101/02

(57) ABSTRACT

A method for testing an LED explosion-proof lamp chamber and a structure thereof aim to be used on a LED explosion-proof lamp. The LED explosion-proof lamp includes a shell and a lighting unit connected to the shell. The shell includes at least one chamber, at least one test portion located at one side of the shell and a sealing assembly connected to the test portion. The test portion includes a test aperture which is sealed by the sealing assembly by screwing and communicates with chamber. The test aperture includes a first thread section and a second thread section connected to the first thread section. The sealing assembly includes a sealing ring, a fastener run through the sealing ring and screwed with the first thread section, and a mask member to cover the fastener and screw with the second thread section. Thus, through a test device and the sealing assembly the sealing efficacy or airtightness of the LED explosion-proof lamp can be secured.

### FIELD OF THE INVENTION

The present invention relates to a method for testing LED explosion-proof lamp chamber and a structure thereof and particularly to a method that can test LED explosion-proof lamp chamber in Ingress Protection (IP) rating and a structure thereof.

### BACKGROUND OF THE INVENTION

In potentially explosive environments or industries such as chemical industry, petrochemical industry, oilfields, coalmines and the like where gases, dust or chemicals with characteristics of inflammable, easy explosion, oxidization or corrosion are often scattering or stored, explosion-proof lamps must be used to avoid explosion caused by sparks generated by worn out or malfunction of ordinary lamps that are not explosion-proof.

If conventional explosion-proof lamps were directly deployed in an explosive environment after they have been finished in production, people working in the explosive environment are threatened in safety. Hence when the explosion-proof lamps are finished in production they must be tested to make sure that they have reached sufficient Ingress Protection rating, thereby operating people can safely work in the explosive environment.

In the past, testing of the explosion-proof lamps to conform to the Ingress protection rating have to adopt varying test measures depending on different sizes of the explosion-proof lamps. A simple and easy test method that is commonly adopted is directly placing an explosion-proof lamp into water to judge whether the lamp has leaking holes. However, such a testing to determine whether the explosion-proof lamp has leaking holes could take nearly one hour or several hours. When the quantity of the explosion-proof lamps increases, time required to do test in the Ingress Protection rating also increases, that could result in waste of time. Hence there is still room for improvement in terms of testing explosion-proof lamps in ingress Protection rating.

### SUMMARY OF THE INVENTION

The primary object of the present invention is to provide a method for testing LED explosion-proof lamp chamber to comply with Ingress Protection rating and a structure thereof.

To achieve the foregoing object the method of the invention comprises the steps as follow:

Step A: Provide a LED explosion-proof lamp which includes a shell contained at least one chamber and at least one test portion located at one side of the shell; the test portion has a test aperture communicating with the chamber;

Step B: Connect a test device to the test aperture;

Step C: Provide a medium to flow from the test device to test aperture and the chamber; and

Step D: Judge whether the medium has flowed out from the LED explosion-proof lamp.

In addition, the present invention also provides a LED explosion-proof lamp chamber test structure that comprises a LED explosion-proof lamp which includes a shell and a lighting unit connected to the shell, the shell has at least one chamber; at least one test portion located at one side of the shell and a sealing assembly connected to the test portion. The test portion has a test aperture communicating with the chamber and sealed by the sealing assembly by screwing. The test aperture includes a first thread section communicating with the chamber and a second thread section communicating with the first thread section and remote from the chamber and being formed at a bore diameter greater than the first thread section. The sealing assembly includes a sealing ring located in the second thread section and abutting the first thread section, a fastener run through the sealing ring and a mask member to cover the fastener.

The invention thus formed provides many advantageous features, notably:

1. The test aperture formed on the shell can be connected to the test device and subject to an internal pressure. It can not only authenticate sealing efficacy of the LED explosion-proof lamp, also can shorten the time of testing the LED explosion-proof lamp in Ingress Protection rating.

2. The invention, by coupling the test aperture with the sealing assembly through screwing, can form secured fastening thereof so that the sealing assembly is less likely loosened away from the test aperture.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flowchart of a method of the invention.

FIG. 2 is an exploded view of a first embodiment of the invention.

FIG. 3 is a perspective view of assembly according to FIG. 2.

FIG. 4 is a fragmentary sectional view according to FIG. 3.

FIG. 5 is a perspective view of the first embodiment collaborated with a test device according to the invention.

FIG. 6 is a schematic view showing medium flow movement inward according to FIG. 5.

FIG. 7 is a perspective view of a second embodiment of the invention.

### DETAILED DESCRIPTION OF THE PREFERRED EMBODIMENTS

Before detailed discussion of the invention, it is to be noted that same elements in different embodiments are labeled with same notations. To facilitate discussion the directional descriptions in the text, such as “up”, “down”, “left”, “right” or the like illustrate the directional relationship of various elements shown in the corresponding drawings, and do not mean to restrict the claims of the invention.

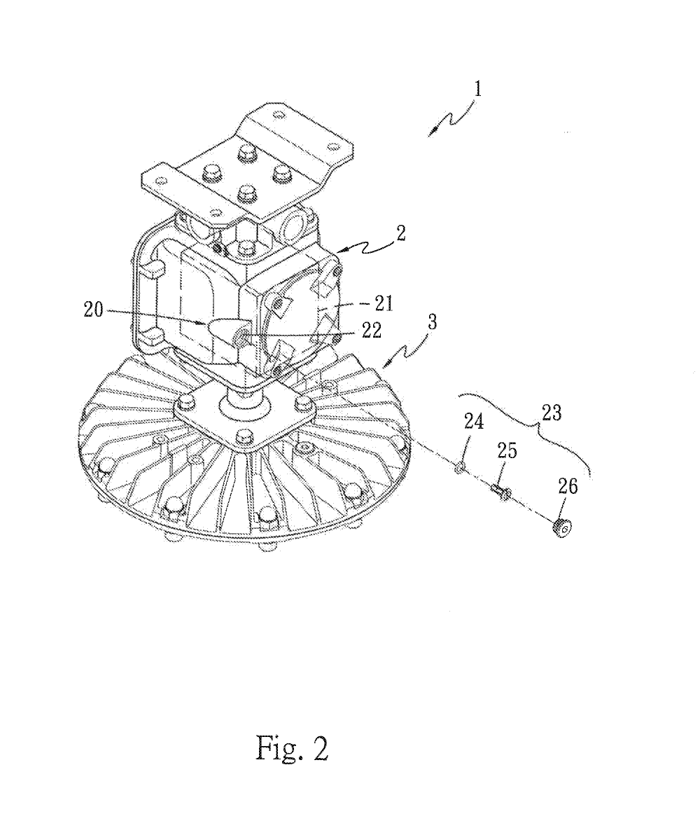

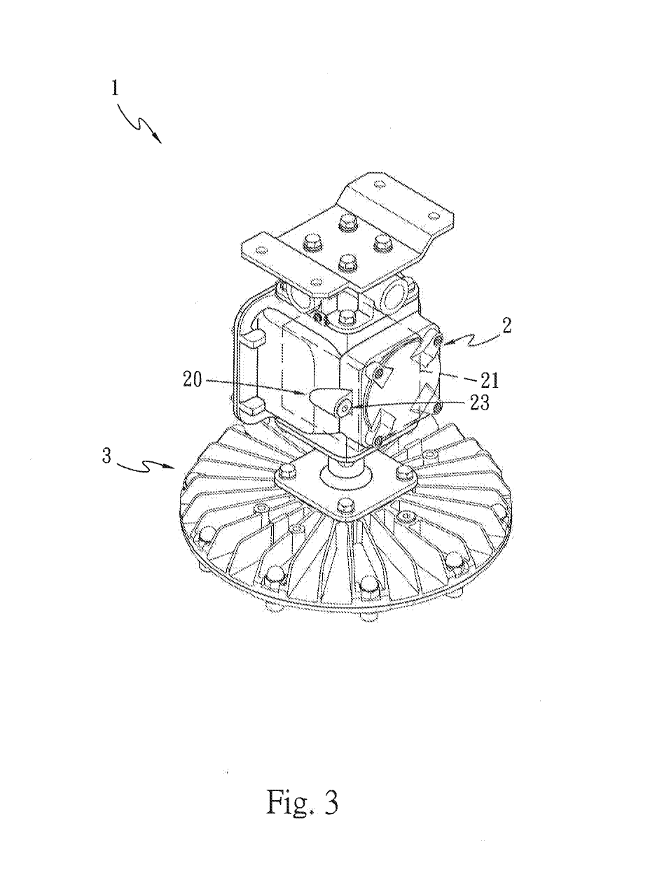

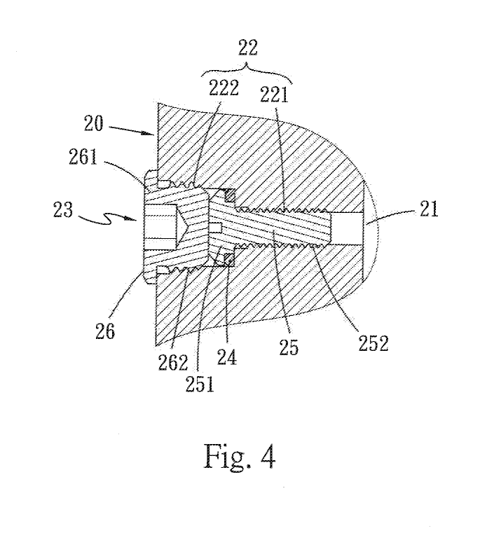

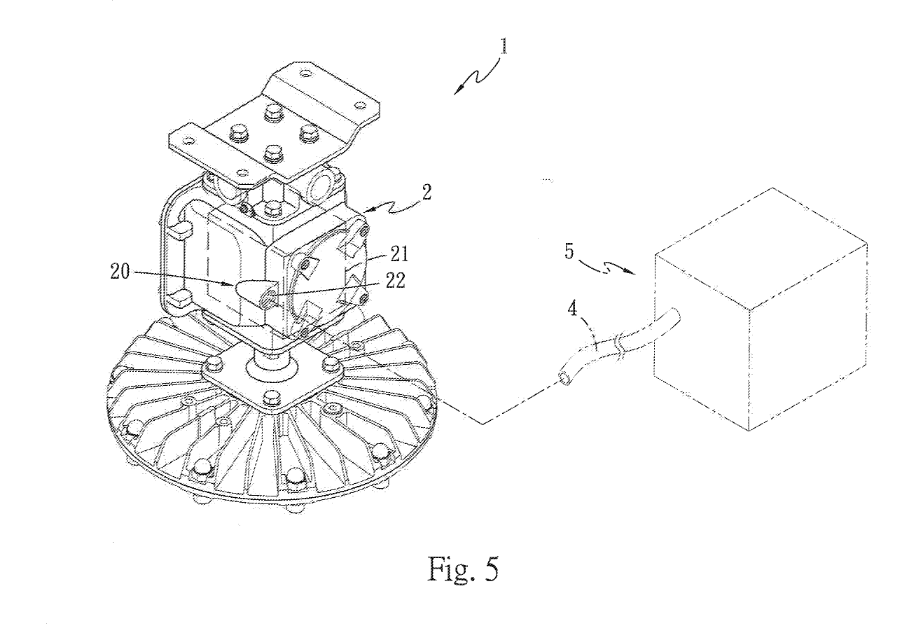

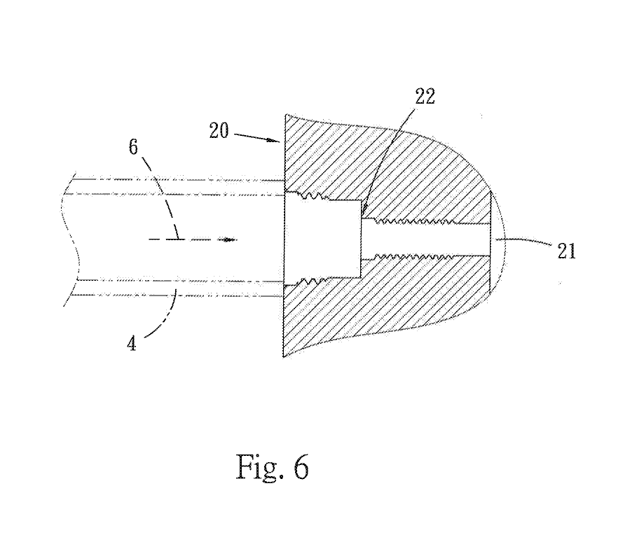

The present invention provides a LED explosion-proof lamp chamber test structure aiming to be used on a LED explosion-proof lamp 1 which includes at least one chamber 21 as shown in FIGS. 2 through 7.

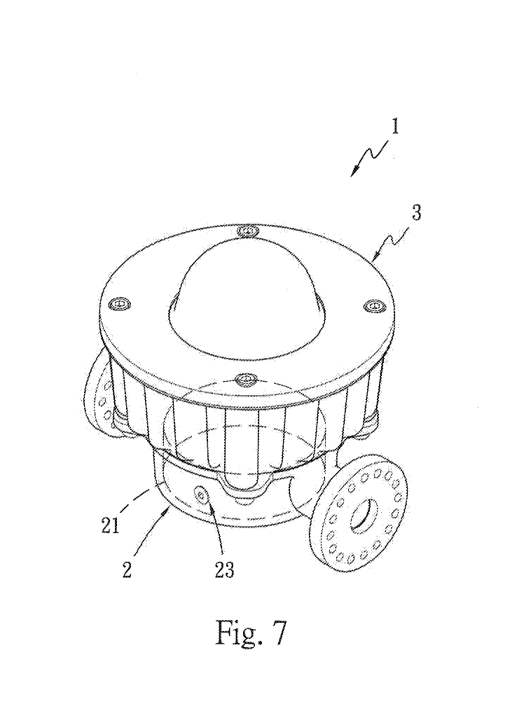

Please also refer to FIGS. 2 through 4 for a first embodiment of the LED explosion-proof lamp chamber test structure of the invention. The LED explosion-proof lamp 1 comprises a shell 2 and a lighting unit 3 connected to the shell 2. The shell 2 includes at least one chamber 21 and at least one test portion 20 located at one side of the shell 2, and a sealing assembly 23 connected to the test portion 20. The test portion 20 has a test aperture 22 communicating with the chamber 21 and sealed by the sealing assembly 23 by screwing. Furthermore, in this embodiment the test portion 20 is one set, but this is not the limitation of the invention. The test aperture 22 includes a first thread section 221 communicated with the chamber 21 and a second thread section 222 communicated with the first thread section 221 and remote from the chamber 21, and being formed at a bore diameter greater than the first thread section 221. In addition, in the event that the test aperture 22 is too large and cannot be fully sealed by the sealing assembly 23, a gap formed in the junction thereof is greater than the smaller inner diameter of the test aperture 22 sealed by the sealing assembly 23. Hence to test the sealing efficacy of the LED explosion-proof lamp 1 that has the test aperture 22 fully sealed, the second thread section 222 should not have an inner diameter formed too large. In this embodiment, the inner diameter of the second to thread section 222 can be set without exceeding two cm, but this is not the limitation of the invention. In this embodiment, the sealing assembly 23 includes a sealing ring 24 located in the second thread section 222 abutting the first thread section 221, a fastener 25 run through the sealing ring 24 and screwed with the first thread section 221, and a mask member 26 covered the fastener 25 and screwed with the second thread section 222. The fastener 25 further includes a top flange 251 to cover the second thread section 222 and a first thread portion 252 extends from the top flange 251 and screwed with the first thread section 221. The mask member 26 further includes a protruding mask flange 261 to cover the second thread section 222 and a second thread portion 262 extends from the protruding mask flange 261 and screwed with the second thread section 222. In other embodiments the mask member 26 can be a clip ring or other elements that can prevent loosening of the fastener 25. In this embodiment, the lighting unit 3 can be located at a lower end of the shell 2 as shown in FIG. 2, also can be connected to an upper end of the shell 2 as shown in FIG. 7, but these also are not the limitation of the invention. In this embodiment the lighting unit 3 can be LED lighting elements, but this also is not the limitation.

As previously discussed, in this embodiment the sealing ring 24 aims to make the actual product to meet requirements of Ingress Protection. In addition, to achieve even more effective sealing, while the sealing assembly 23 has screwed and sealed the test aperture 22, a sealing compound such as thermal plastics or thermal silicone can be applied on a portion thereof, such as between the top flange 251 and the second thread section 222, thereby to strengthen coupling of the sealing assembly 23 and the test aperture 22.

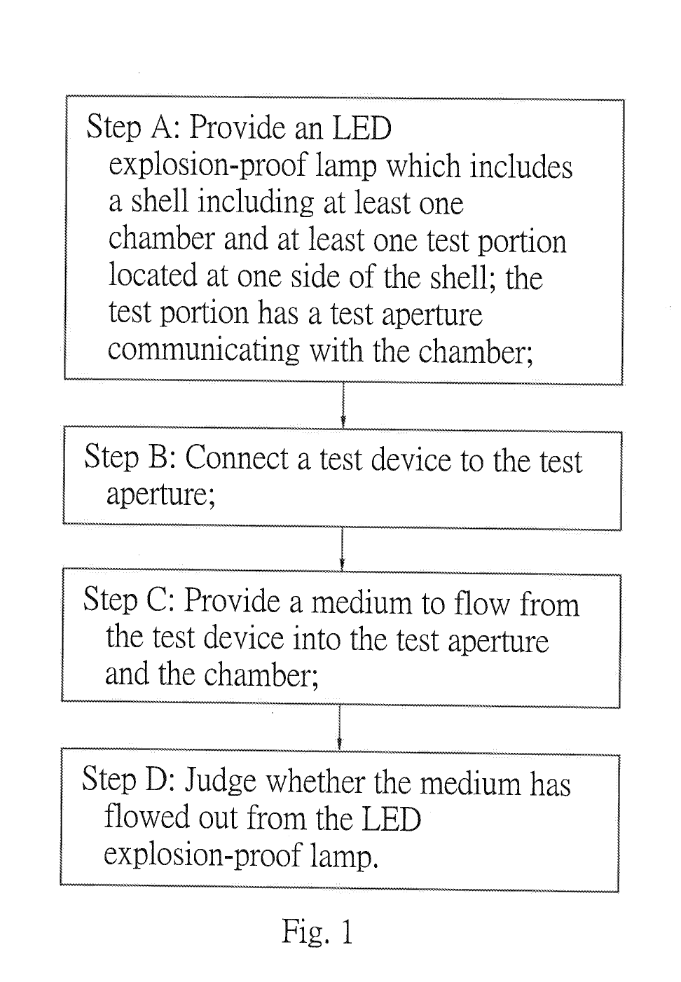

To ensure that the LED explosion-proof lamp 1 has reached desired Ingress Protection, the present invention further provides a method for testing LED explosion-proof lamp chamber, please referring to FIGS. 1, 5 and 6. The test aperture 22 is connected to a connection tube 4 and a test device 5 connected to the connection tube 4 to test the LED explosion-proof lamp 1 to meet the Ingress Protection rating. The test device 5 provides a medium 6 such as gas or liquid to pass through the test aperture 22 and enter the chamber 21 of the shell 2. In this embodiment the test device 5 can be a gas pump to provide gas or a liquid pump to provide liquid, but this is not the limitation of the invention. The method for testing the LED explosion-proof lamp chamber includes the steps as follow:

Step A: Provide a LED explosion-proof lamp 1 that includes a shell 2 which has at least one chamber 21 and at least one test portion 20 located at one side of the shell 2; the test portion has a test aperture 22 communicating with the chamber 21;

Step B: Connect a test device 5 to the test aperture 22;

Step C: Provide a medium 6 to flow from the test device 5 to the test aperture 22 and the chamber 21. In this embodiment the medium 6 can be a gas. The LED explosion-proof lamp 1 connected with the test device 5 is put into water to allow operating people to do judgment at the next step. Preferably the time of placing into the water is ten seconds or ranged from ten seconds to thirty seconds, but is not limited to that duration. Then the test device 5 provides a pressure at least twice of a standard gas pressure to avoid the LED explosion-proof lamp 1 from deforming due to too much internal pressure that might result in creating cracks thereon. A preferable approach is to provide a pressure this is three to five times of the standard gas pressure, with each standard pressure at 101325 Pascal (Pa), or let the test device 5 providing a gas pressure of five kg or five to ten kg, but not limited to such instances; and

Step D: Judge whether the medium 6 has flowed out from the LED explosion-proof lamp 1. In the event that a leaking hole (not shown in the drawings) is formed on the outer side of the LED explosion-proof lamp 1 and leaded to the chamber 21, the gas in the chamber 21 flows toward the leaking hole, and the gas outside the leaking hole thrusts into the water to generate air bubbles, then it can be judged that sealing of the LED explosion-proof lamp 1 is deficient and needs mending. In other embodiments the judgment can be made on whether connection between the elements is tight enough, such as the joined surface of the lower end of the shell 2 and the lighting unit 3. If the joined surface is not tight enough air bubbles also are generated at the joined spot, then mending can be made, but this is not the limitation of the invention.

In another embodiment the medium 6 can be liquid. According to steps C and D, the LED explosion-proof lamp 1 connected with the test device 5 is held in the air, and the test device 5 provides a standard flow speed that is at least twice as much. The standard flow speed is 20 m/s (meter per second). In the event that a leaking hole (not shown in the drawings) is formed on the outer side of the LED explosion-proof lamp 1 and leaded to the chamber 21, the liquid in the chamber 21 flows toward the leaking hole, and also flows outside the leaking hole, then it can be judged that sealing of the LED explosion-proof lamp 1 is deficient and needs mending. Similarly, to avoid the LED explosion-proof lamp 1 from deforming due to too much internal pressure that might result in creating cracks thereon, a preferable approach is to provide the standard flow speed at four to six times as much, but not limited to such instances.

Please refer to FIG. 7 for a second embodiment of the LED explosion-proof lamp chamber test structure of the invention. It is structured substantially like the first embodiment shown in FIG. 2. It differs by mounting the lighting unit 3 on an upper end of the shell 2, and a test aperture (not shown in the drawings) same as that in the first embodiment is formed on a wall surface at one side of the shell 2, then the method for testing the LED explosion-proof lamp chamber previously discussed can be adopted to test the sealing efficacy of the LED explosion-proof lamp 1. After the test is finished, if no leaking hole is found on the outer side of the LED explosion-proof lamp 1 leading to the chamber 21, it can be sealed via the sealing assembly 23. In the event that a leaking hole is found on the outer side of the LED explosion-proof lamp 1, mending can be made immediately. The testing method of the invention set forth above is not limited to the two types of LED explosion-lamp 1 previously discussed.

As a conclusion, the invention, through the test aperture leading to the chamber that is connected to the test device, and collaborated with the testing method mentioned above, can test the sealing efficacy of the LED explosion-proof lamp. The test aperture is coupled with the sealing assembly by screwing and is formed with an inner bore diameter not exceeding two cm, thus can be fully sealed to enable the LED explosion-proof lamp to achieve sufficient sealing efficacy or air tightness.

What is claimed is:

1. A method for testing an LED explosion-proof lamp chamber, comprising the steps of:
Step A: providing an LED explosion-proof lamp which includes a shell included at least one chamber in the shell and at least one test portion located at one side of the shell, the test portion including a test aperture communicating with the chamber;
Step B: connecting a test device to the test aperture;
Step C: providing a medium to flow from the test device to the test aperture and the chamber; and
Step D: judging whether the medium has flowed out from the LED explosion-proof lamp.

2. The method for testing an LED explosion-proof lamp chamber of claim 1, wherein the medium at the step C is gas which enters the test aperture at a pressure at least twice as much as a standard atmosphere, the standard atmosphere being 101325 Pascal (Pa).

3. The method for testing an LED explosion-proof lamp chamber of claim 2, wherein the step C also includes a sub-step of placing the LED explosion-proof lamp connected to the test device into water for at least ten seconds.

4. The method for testing an LED explosion-proof lamp chamber of claim 1, wherein the medium at the step C is a liquid which enters the test aperture at a flow speed at least twice as much as a standard flow speed, the standard flow speed being twenty meters per second (20 m/s).

5. An LED explosion-proof lamp chamber test structure, comprising:
an LED explosion-proof lamp which includes a shell and a lighting unit connected to the shell, the shell including at least one chamber therein, at least one test portion located at one side thereof, and a sealing assembly connected to the test portion;
wherein the test portion includes a test aperture which is sealed by the sealing assembly by screwing and communicates with the chamber.

6. The LED explosion-proof lamp chamber test structure of claim 5, wherein the test aperture includes a first thread section communicating with the chamber and a second thread section communicating with the first thread section and remote from the chamber and being formed at a bore diameter greater than that of the first thread section.

7. The LED explosion-proof lamp chamber structure of claim 6, wherein the sealing assembly includes a sealing ring located in the second thread section and abutting the first thread section, a fastener run through the sealing ring, and a mask member; the fastener including a top flange to cover the first thread section and a first thread portion extending from the top flange and screwed with the first thread section; the mask member including a protruding mask flange to cover the second thread section and a second thread portion extending from the protruding mask flange and screwed with the second thread section.
